(19) United States
(12) Patent Application Publication
(10) Pub. No.: US 2026/0052548 A1
(43) Pub. Date: Feb. 19, 2026

(54) DEVICE, METHOD AND COMPUTER READABLE MEDIUM FOR SIDELINK COMMUNICATIONS

(71) Applicant: Nokia Technologies Oy, Espoo (FI)

(72) Inventors: Renato Barbosa ABREU, Aalborg (DK); Nuno Manuel KIILERICH PRATAS, Aalborg (DK); Timo Erkki LUNTTILA, Espoo (FI); Jian Guo LIU, Shanghai (CN); Vinh VAN PHAN, Oulu (FI); Yong LIU, Shanghai (CN); Laura Luque SANCHEZ, Aalborg (DK); Torsten WILDSCHEK, Gloucester (GB); Naizheng ZHENG, Beijing (CN)

(21) Appl. No.: 19/101,744

(22) PCT Filed: Aug. 22, 2022
(86) PCT No.: PCT/CN2022/114059

§ 371 Date: Feb. 6, 2025

(51) Int. Cl. H04W 72/25; H04L 1/1812

(52) U.S. Cl. CPC H04W 72/25; H04L 1/1812

(57) ABSTRACT

Embodiments of the present disclosure relate to method, device and computer readable media for sidelink communications. A first device obtains a configuration of a first PSFCH resource in a secondary band. The first PSFCH resource is for HARQ feedback information in response to a sidelink data transmission from a second device in an operating unlicensed band. The secondary band comprises a non-congested unlicensed band or a band where a channel access procedure is not required. The first device determines whether the HARQ feedback information is to be transmitted on the first PSFCH resource in the secondary band. The first device transmits, to the second device, the HARQ feedback information on the first PSFCH resource in accordance with a determination that the HARQ feedback information is to be transmitted on the first PSFCH resource in the secondary band.

### TECHNICAL FIELD

Implementations of the present disclosure generally relate to the field of telecommunication, and in particular, to devices, methods and computer readable media for sidelink communications.

### BACKGROUND

New Radio (NR) supports sidelink to provide reliable, low latency and high-speed device-to-device (D2D) communications for various applications especially in vehicle-to-everything (V2X) scenarios. In NR sidelink, a user equipment (UE) may transmit to one or more UEs by unicast, groupcast or broadcast under or without control of the network. A hybrid automatic retransmission request (HARQ) mechanism is also introduced in NR sidelink to ensure reliability of the sidelink transmissions.

### SUMMARY

The scope of protection sought for various embodiments of the invention is set out by the independent claims. The [embodiments/examples] and features, if any, described in this specification that do not fall under the scope of the independent claims are to be interpreted as examples useful for understanding various embodiments of the invention.”

Please note that the term “embodiments” or “examples” should be adapted accordingly to the terminology used in the application, i.e. if the term “examples” is used, then the statement should talk of “examples” accordingly, or if the term “embodiments” is used, then the statement should talk of “embodiments” accordingly.

In general, example implementations of the present disclosure provide devices, methods and computer readable media for sidelink communications.

In a first aspect, there is provided a first device. The first device comprises at least one processor and at least one memory including computer program codes. The at least one memory and the computer program codes are configured to, with the at least one processor, cause the first device to: obtain a configuration of a first Physical Sidelink Feedback Channel (PSFCH) resource in a secondary band, the first PSFCH resource being for Hybrid Automatic Repeat Request (HARQ) feedback information in response to a sidelink data transmission from a second device in an operating unlicensed band, the secondary band comprising a non-congested unlicensed band or a band where a channel access procedure is not required; and in accordance with a determination that the HARQ feedback information is to be transmitted on the first PSFCH resource in the secondary band, transmit, to the second device, the HARQ feedback information on the first PSFCH resource.

In a second aspect, there is provided a second device. The second device comprises at least one processor and at least one memory including computer program codes. The at least one memory and the computer program codes are configured to, with the at least one processor, cause the second device to: obtain a configuration of a first PSFCH resource in a secondary band, the first PSFCH resource being for HARQ feedback information in response to a sidelink data transmission from the second device in an operating unlicensed band, the secondary band comprising a non-congested unlicensed band or a band where a channel access procedure is not required; determine whether to receive the HARQ feedback information on the first PSFCH resource in the secondary band; and in accordance with a determination that the HARQ feedback information is to be received on the first PSFCH resource in the secondary band, receive, from a first device, the HARQ feedback information on the first PSFCH resource.

In a third aspect, there is provided a method implemented at a first device. The method comprises: obtaining a configuration of a first PSFCH resource in a secondary band, the first PSFCH resource being for HARQ feedback information in response to a sidelink data transmission from a second device in an operating unlicensed band, the secondary band comprising a non-congested unlicensed band or a band where a channel access procedure is not required; and in accordance with a determination that the HARQ feedback information is to be transmitted on the first PSFCH resource in the secondary band, transmitting, to the second device, the HARQ feedback information on the first PSFCH resource.

In a fourth aspect, there is provided a method implemented at a second device. The method comprises: obtaining a configuration of a first PSFCH resource in a secondary band, the first PSFCH resource being for HARQ feedback information in response to a sidelink data transmission from the second device in an operating unlicensed band, the secondary band comprising a non-congested unlicensed band or a band where a channel access procedure is not required; determining whether to receive the HARQ feedback information on the first PSFCH resource in the secondary band; and in accordance with a determination that the HARQ feedback information is to be received on the first PSFCH resource in the secondary band, receiving, from a first device, the HARQ feedback information on the first PSFCH resource.

In a fifth aspect, there is provided an apparatus. The apparatus comprises: means for obtaining a configuration of a first PSFCH resource in a secondary band, the first PSFCH resource being for HARQ feedback information in response to a sidelink data transmission from a second device in an operating unlicensed band, the secondary band comprising a non-congested unlicensed band or a band where a channel access procedure is not required; and means for transmitting, to the second device, the HARQ feedback information on the first PSFCH resource in accordance with a determination that the HARQ feedback information is to be transmitted on the first PSFCH resource in the secondary band.

In a sixth aspect, there is provided an apparatus. The apparatus comprises: means for obtaining a configuration of a first PSFCH resource in a secondary band, the first PSFCH resource being for HARQ feedback information in response to a sidelink data transmission from the second device in an operating unlicensed band, the secondary band comprising a non-congested unlicensed band or a band where a channel access procedure is not required; means for determining whether to receive the HARQ feedback information on the first PSFCH resource in the secondary band; and means for receiving, from a first device, the HARQ feedback information on the first PSFCH resource in accordance with a determination that the HARQ feedback information is to be received on the first PSFCH resource in the secondary band.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of implementations of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some implementations of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of acquisition of Channel Occupancy Time (COT) in accordance with some implementations of the present disclosure;

FIG. 3 illustrates an example of a contention window countdown procedure in accordance with some implementations of the present disclosure;

FIGS. 4 and 5 illustrate an example of allowed gaps for which Type 2 Listen Before Talk (LBT) procedures to be applicable in accordance with some implementations of the present disclosure, respectively;

FIG. 6 illustrates an example of an initiating device communicating through sidelink (SL) with a plurality of responding devices under respectively acquired COTs using different types of LBT procedures according to an implementation;

FIG. 7 illustrates an example of NR SL resource allocation in mode 2 in accordance with some implementations of the present disclosure;

FIG. 8 illustrates an example of an SL slot structure in accordance with some implementations of the present disclosure;

FIG. 9 illustrates an example of mapping between PSSCH resources and PSFCH resources in accordance with some implementations of the present disclosure;

FIG. 10 illustrates a signaling chart illustrating a process for transmission of HARQ feedback information in accordance with some implementations of the present disclosure;

FIG. 11 illustrates an example of allocation of PSFCH resources in a secondary band in accordance with some implementations of the present disclosure;

FIG. 12 illustrates an example of allocation of PSFCH resources in a secondary band in accordance with other implementations of the present disclosure;

FIG. 13 illustrates a flowchart of an example method in accordance with some implementations of the present disclosure;

FIG. 14 illustrates a flowchart of another example method in accordance with some implementations of the present disclosure;

FIG. 15 illustrates a simplified block diagram of an apparatus that is suitable for implementing embodiments of the present disclosure; and

FIG. 16 illustrates a block diagram of an example computer readable medium in accordance with some implementations of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

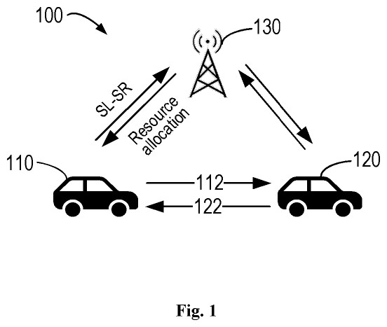

FIG. 1 illustrates a schematic diagram of an example communication network 100 in which implementations of the present disclosure can be implemented. As shown in FIG. 1, the communication network 100 may include a first device 110, a second device 120 and a third device 130. The third device 130 may communicate with the first device 110 and the second device 120 via respective wireless communication channels.

In this example, only for ease of discussion, the first device 110 and the second device 120 are illustrated as vehicles which enable V2X communications and the third device 130 is illustrated as a network device serving the vehicles 110 and 120. It is to be understood that the vehicles and the network device are only example implementations of the first device 110, the second device 120 and the third device 130, respectively, without suggesting any limitation as to the scope of the present application. Any other suitable implementations are possible as well.

It is to be understood that the number of devices 110, 120 and 130 in FIG. 1 is given for the purpose of illustration without suggesting any limitations to the present disclosure. The communication network 100 may include any suitable number of devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In an example, communications in the communication network 100 may be performed in new radio (NR) operation in an unlicensed band. In some implementations, the communications in the communication network 100 may include SL communications 112 and 122. For example, via the SL communication 122, the second device 120 performs a sidelink data transmission to the first device 110. Via the SL communication 112, the first device 110 transmits, to the second device 120, HARQ feedback information associated with the sidelink data transmission.

### Unlicensed Operation Background

In sub-7 GHz unlicensed bands, the new radio (NR) coexistence with other systems (e.g. IEEE 802.11) may be ensured via an LBT channel access mechanism. According to the channel access mechanism, a user equipment (UE) (such as, the first device 110 or the second device 120) intending to perform an SL communication (such as the SL communication 112 or 122) may need first to successfully complete an LBT check, before being able to initiate the same SL communication. Hereinafter, an LBT procedure may also be referred to as Clear Channel Assessment (CCA) or channel access procedure.

For a UE to pass an LBT check, it must observe the channel as available for a number of consecutive CCA slots. In sub-7 GHz, the duration of these slots is 9 μs. The UE deems the channel as available in a CCA slot if the measured power (i.e. the collected energy during the CCA slot) is below a regulatory specified threshold which may depend on the operating band and geographical region.

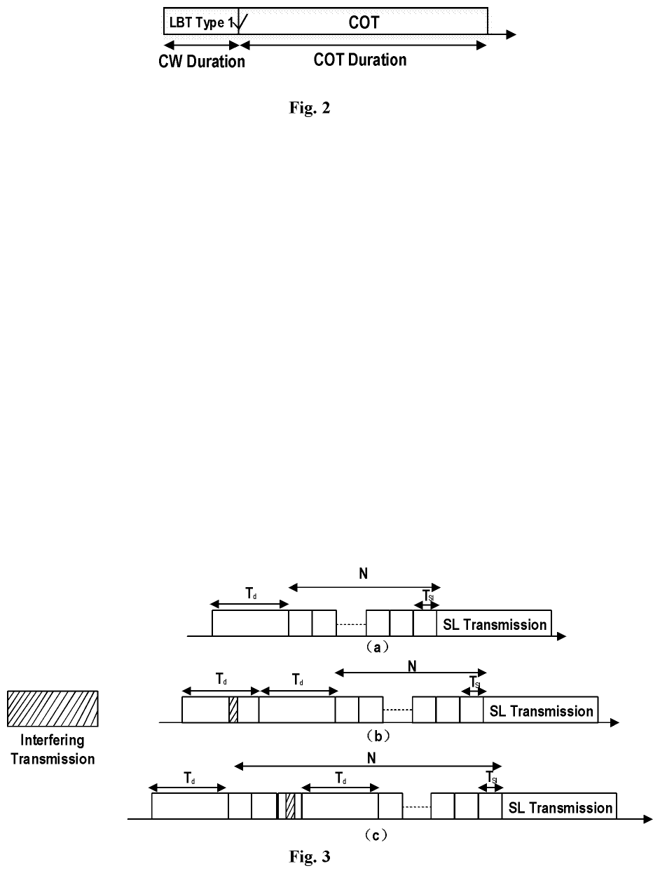

In an example, when a UE (e.g., the first device 110) takes a role of an initiating device to initiate a communication with a responding device (e.g., the second device 120), this initiating UE may need to acquire the “right” to access the channel for a certain period of time—as denoted in the regulations as the COT—by applying an “extended” LBT procedure where the channel must be deemed as free for the entire duration of a Contention Window (CW). This “extended” LBT procedure is commonly known as a Type 1 LBT procedure or LBT Type 1 procedure as specified in TS 37.213. This procedure is illustrated in FIG. 2.

Both of a CW duration and a COT duration in FIG. 2 may depend on the Channel Access Priority Class (CAPC) associated with the UE's traffic (e.g., p=1 to p=4), as shown in Table 1. Control plane traffic (such as physical sidelink control channel (PSCCH)) may be transmitted with a priority of p=1, while user plane traffic has a priority of p>1. Table 1 depicts details of the Type 1 LBT for the Uu uplink (UL) case. It may be noted that in the

TABLE 1

| Channel | | | | | |
|---|---|---|---|---|---|
| Access | | | | | |
| Priority | | | | | |
| Class (p) | mₚ | CW_{min, p} | CW_{max, p} | T_{ulm cot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, 255, 511, 1023} |
| | | | | 10 ms | |
| 4 | 7 | 15 | 1023 | 6 ms or | {15, 31, 63, 127, 255, 511, 1023} |
| | | | | 10 ms | |

NOTE1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 us. The maximum duration before including any such gap shall be 6 ms.

Table 1 shows CAPC for UL. The contention window length in CCA slots associated with each CAPC has a minimum (CW_{min,p}) and maximum (CW_{max,p}). The duration of the COT is given by T_{ulm cot, p}.

Examples of behavior during the contention window countdown procedure are depicted in FIG. 3. It should be noted that if during the countdown procedure the LBT check fails in any CCA slot, the countdown procedure will stop and will only resume if the channel is deemed as free (i.e. the LBT check is successful) during a defer time.

In FIG. 3, T_{d} represents the defer time, Tₛₗ represents the CCA slot duration and N represents the number of CCA slots required to be deemed as free before the contention window countdown is completed. Specifically, FIG. 3 shows a Type 1 LBT contention window countdown procedure and examples on how it can be disrupted. In example (a), when neither the defer time T_{d} nor the countdown are disrupted (i.e., the channel is not detected as busy during a sensing slot). In example (b), the defer time T_{d} is disrupted (i.e., the channel is detected as busy during a defer time sensing slot). In example (c), the contention window countdown is disrupted (i.e., the channel is detected as busy during a sensing slot of the countdown).

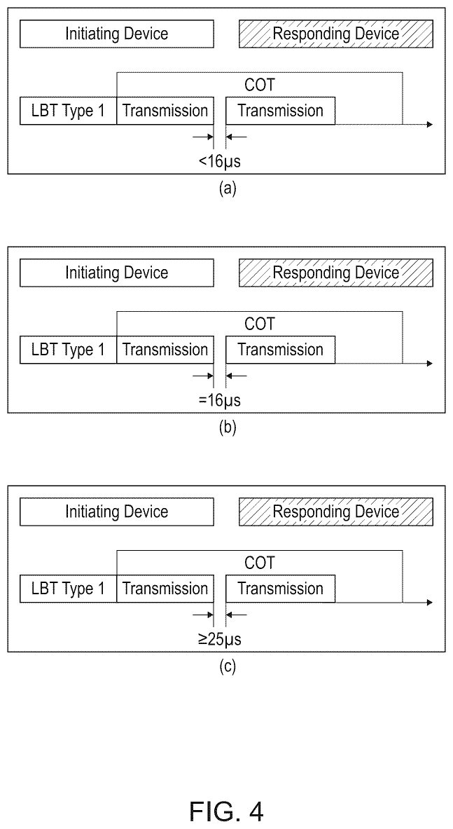

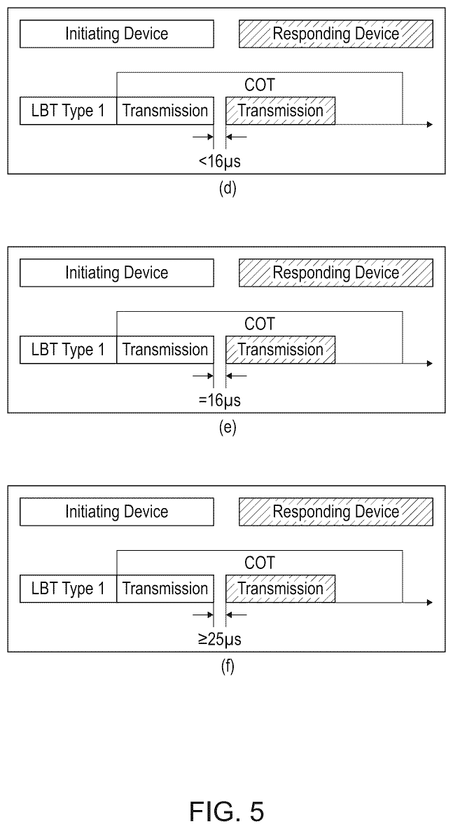

The UE initiating the transmission (also referred to as the initiating device, e.g., the second device 120) upon successfully completing performing the Type 1 LBT procedure and performing a transmission (e.g., to the first device 110), may acquire the COT with duration associated with a priority p in the corresponding CAPC. The acquired COT may be valid even in the case where the initiating device may pause its transmission, although if the initiating device wants to perform a new transmission (within the COT) it may still be required to perform a “reduced” LBT procedure. This “reduced” LBT procedure is commonly known as a Type 2 LBT procedure or LBT Type 2 procedure with the following variants:
Type 2A (25 μs LBT)—for SL transmissions within a COT that the initiating device acquires (in case the gap between two SL transmissions is ≥25 μs, as well for SL transmissions following another SL transmission), as depicted in example (c) in FIG. 4 and example (f) in FIG. 5;
Type 2B (16 μs LBT)—for SL transmission within a COT that the initiating device acquires (can only be used for SL transmissions following another SL with a gap exactly equal to 16 μs), as depicted in example (b) in FIG. 4 and example (e) in FIG. 5;
Type 2C (no LBT)—which can only be used for SL transmission following another SL, with a gap<16 μs and the allowed duration of the SL transmission ≤584 μs, as depicted in example (a) in FIG. 4 and example (d) in FIG. 5.

In addition, the examples (a), (b) and (c) show the case where the gap is between the two transmissions both from the same initiating UE (i.e., device 110), while the examples (d), (e), and (f) show the case that the gap is between the two different transmissions from the initiating UE (e.g., the second device 120) and the responding UE (e.g., the first device 110), correspondingly.

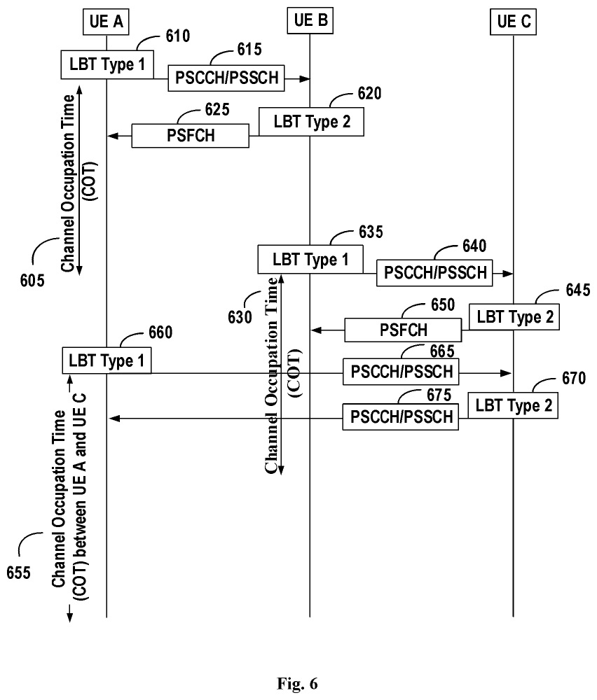

The initiating device (e.g., the second device 120) may share its acquired COT with its intended receiver (also referred to as the responding device (e.g., the first device 110)). For this purpose, the initiating device shall inform (e.g., via control signaling) the responding device about the duration of this COT. The responding device then uses this information to decide which type of LBT procedure it should apply upon performing a transmission for which the intended receiver is the initiating device. In case the responding device transmission falls outside the COT, then the responding device will have to acquire a new COT using the Type 1 LBT with an appropriate class p in the CAPC. This will be described with reference to FIG. 6.

FIG. 6 illustrates an example of an initiating device communicating through sidelink with a plurality of responding devices under respectively acquired COTs using different types of LBT procedures, according to an implementation. According to FIG. 6, an initiating device (i.e., UE A) may first acquire a new COT 605 using a Type 1 LBT procedure 610. The initiating device (UE A) may then transmit through a sidelink transmission 615 on PSCCH and/or physical sidelink shared channel (PSSCH) to a first responding device (UE B). In addition, UE A may share its acquired COT 605 with UE B. UE B may then use this acquired COT 605 information to decide which type of LBT procedure it should apply when performing a transmission to UE A as an intended receiver. In practice, UE A may inform (e.g. via control signaling) UE B about a duration of the COT 605 within the SL transmission 615. In response, UE B may be configured to perform a Type 2 LBT procedure 620 and transmit SL feedback information 625 to UE A, on the PSFCH.

Alternately, UE B may communicate with another responding device (e.g., UE C). In case a transmission from UE B to UE C falls outside the duration of the COT 605, UE B may need to acquire a new COT 630 using the Type 1 LBT procedure 635 according to an appropriate class p in the CAPC. UE B may then transmit SL transmission 640 on the PSCCH and/or PSSCH to UE C and share its acquired COT 630 with UE C. UE C may use the COT 630 information to decide which type of LBT procedure UE C should apply when performing a transmission to UE B as the intended receiver. In practice, UE B may inform (e.g. via control signaling) UE C about the duration of the COT 630 within the SL transmission 640. In response, UE C may be configured to perform a Type 2 LBT procedure 645 and transmit SL feedback information 650 to UE B on the PSFCH.

If UE A wants to perform a transmission to UE C, then UE A may need to acquire another new COT 655 using the Type 1 LBT procedure 660 with an appropriate CAPC. For example, UE A may need to acquire the new COT 655 using a Type 1 LBT procedure 660 with an appropriate class p in the CAPC. UE A may transmit SL transmission 665 on PSCCH and/or PSSCH to UE C. In addition, UE A may also share the duration in the acquired COT 655 with UE C (e.g. via control signaling). UE C may then use this duration information of the COT 655 to decide which type of LBT procedure UE C should apply when performing a transmission to UE A as the intended receiver. Upon receiving the SL transmission 665 with the duration information of the COT 655, UE C may successfully perform a Type 2 LBT procedure 670 and transmits SL feedback information 675 on PSFCH to UE A.

### NR-SL Overview

NR SL has been designed to facilitate a UE to communicate with other nearby UE(s) via direct/SL communication. Two resource allocation modes have been specified, and a SL transmitter (TX) UE (such as the first device 110 or the second device 120) is configured with one of them to perform its NR SL transmissions. These modes are denoted as NR SL mode 1 and NR SL mode 2. In mode 1, a sidelink transmission resource is assigned or scheduled by a network device (such as the third device 130) to the SL TX UE, while a SL TX UE in mode 2 autonomously selects its SL transmission resources.

In mode 1, the network device (such as the third device 130) is responsible for SL resource allocation, the configuration and operation is similar to the one over the Uu interface, as shown in FIG. 1. In mode 1, it is possible to configure a single resource pool spanning the whole spectrum including the unavailable part(s), but the network device schedules only sub-channels containing available PRBs. When the UE has data to transmit, it can request resources to the network device via SL-BSR MAC CE or via PUCCH resource configured for a SL logical channel to send SR, as shown in FIG. 1. A dynamic sidelink grant DCI (DCI format 30) may grant sidelink resources for up to three transmissions of a transport block. The network device may also provide one or multiple configured grants allocating periodic sidelink resources. The MAC level details of this procedure are given in section 5.8.3 of 38.321.

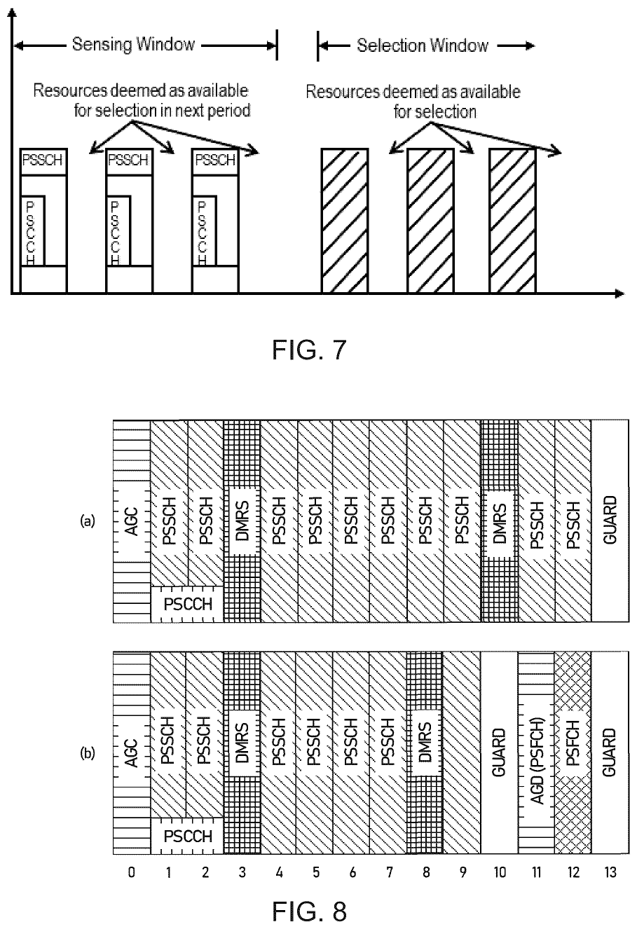

FIG. 7 illustrates an example of NR SL resource allocation in mode 2. In mode 2, SL UEs perform autonomously the resource selection with the aid of a sensing procedure. More specifically, a SL TX UE in NR SL mode 2 first performs a sensing procedure over the configured one or more SL transmission resource pools in order to obtain the knowledge of one or more reserved resources by at least one other nearby SL TX UE. Based on the knowledge obtained from sensing, the SL TX UE may select at least one resource from the available SL resources accordingly. In order for a SL UE to perform sensing and obtain the necessary information to receive a SL transmission, it needs to decode the sidelink control information (SCI). In Release 16, the SCI associated with a data transmission includes a 1st-stage SCI and 2nd-stage SCI.

### Sidelink Control Information (SCI)

The SCI follows a 2-stage SCI structure, whose main motivation is to support the size difference between the SCIs for various NR-V2X SL service types (e.g., broadcast, groupcast and unicast).

The 1st-stage SCI may comprise SCI format 1-A, which is carried by PSCCH. The 1st-stage SCI contains at least one of the following: information to enable sensing operations, or information needed to determine resource allocation of the PSSCH and to decode 2nd-stage SCI. Table 2 shows an example of the contents of the 1st-stage SCI.

```
TABLE 2
From 38.212:
8.3.1.1 SCI format 1-A
SCI format 1-A is used for the scheduling of PSSCH and 2^{nd}-stage-SCI on PSSCH
The following information is transmitted by means of the SCI format 1-A:
  - Priority - 3 bits as defined in clause 5.4.3.3 of [12, TS 23.287].
  $‐ Frequency resource assignment - ⌈ {log}_{2} ( \frac{{N}_{subChannel}^{SL} ( {N}_{subChannel}^{SL} + 1 )}{2} ) ⌉ bits when the$
value of the higher layer parameter sl-MaxNumPerReserve is configured to 2; otherwise
$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer$
parameter sl-MaxNumPerReserve is configured to 3, as defined in clause 8.1.2.2 of [6,
TS 38.214].
  - Time resource assignment - 5 bits when the value of the higher layer parameter
sl-MaxNumPerReserve is configured to 2; otherwise 9 bits when the value of the higher
layer parameter sl-MaxNumPerReserve is configured to 3, as defined in clause 8.1.2.1
of [6, TS 38.214].
  - Resource reservation period - ┌log₂Nᵣₛᵥ_period┐ bits as defined in clause 8.1.4
of [6, TS 38.214], where Nᵣₛᵥ_period is the number of entries in the higher layer
parameter sl-ResourceReservePeriodList, if higher layer parameter
sl-MultiReserveResource is configured; 0 bit otherwise.
  - DMRS pattern - ┌log₂Nₚₐₜₜₑᵣₙ┐ bits as defined in clause 8.4.1.1.2 of [4, TS
38.211], where Nₚₐₜₜₑᵣₙ is the number of DMRS patterns configured by higher layer
parameter sl-PSSCH-DMRS-TimePatternList; 0 bit if sl-PSSCH-DMRS-TimePatternList
is not configured.
  - 2^{nd}-stage SCI format - 2 bits as defined in Table 8.3.1.1-1.
  - Beta_offset indicator - 2 bits as provided by higher layer parameter
sl-BetaOffsets2ndSCI and Table 8.3.1.1-2.
  - Number of DMRS port - 1 bit as defined in Table 8.3.1.1-3.
  - Modulation and coding scheme - 5 bits as defined in clause 8.1.3 of [6, TS
38.214].
  - Additional MCS table indicator - as defined in clause 8.1.3.1 of [6, TS
38.214]: 1 bit if one MCS table is configured by higher layer parameter
sl-Additional-MCS-Table; 2 bits if two MCS tables are configured by higher layer
parameter sl-Additional-MCS-Table; 0 bit otherwise.
  - PSFCH overhead indication - 1 bit as defined clause 8.1.3.2 of [6, TS 38.214]
if higher layer parameter sl-PSFCH-Period = 2 or 4; 0 bit otherwise.
  - Reserved - a number of bits as determined by higher layer parameter
sl-NumReservedBits, with value set to zero.
Table 8.3.1.1-1: 2^{nd}-stage SCI formats
```

| Value of 2nd-stage | |
|---|---|
| SCI format field | 2nd-stage SCI format |
| 00 | SCI format 2-A |
| 01 | SCI format 2-B |
| 10 | Reserved |
| 11 | Reserved |

The 2nd-stage SCI may comprise SCI formats 2-A and 2-B, which are carried by PSSCH (multiplexed with SL-SCH) and contain at least one of the following:
Source and destination identities
information to identify and decode the associated SL-SCH TB
control of HARQ feedback in unicast/groupcast
trigger for CSI feedback in unicast

Table 3 shows an example of the contents of the 2nd-stage SCI.

TABLE 3

| SCI Format 2-A | SCI Format 2-B |
|---|---|
| HARQ process number - 4 bits. | HARQ process number - 4 bits. |
| New data indicator - 1 bit. | New data indicator - 1 bit. |
| Redundancy version - 2 bits as | Redundancy version - 2 bits as defined |
| defined in Table 7.3.1.1.1-2. | in Table 7.3.1.1.1-2. |
| Source ID - 8 bits as defined in | Source ID - 8 bits as defined in clause |
| clause 8.1 of [6, TS 38.214]. | 8.1 of [6, TS 38.214]. |
| Destination ID - 16 bits as defined in | Destination ID - 16 bits as defined in |
| clause 8.1 of [6, TS 38.214]. | clause 8.1 of [6, TS 38.214]. |
| HARQ feedback enabled/disabled | HARQ feedback enabled/disabled |
| indicator - 1 bit as defined in clause 16.3 | indicator - 1 bit as defined in clause 16.3 of |
| of [5, TS 38.213]. | [5, TS 38.213]. |
| Cast type indicator - 2 bits as | Zone ID - 12 bits as defined in clause |
| defined in Table 8.4.1.1-1 and in clause | 5.8.11 of [9, TS 38.331]. |
| 8.1 of [6, TS 38.214]. | Communication range requirement - 4 |
| CSI request - 1 bit as defined in | bits determined by higher layer parameter |
| clause 8.2.1 of [6, TS 38.214] and in | sl-ZoneConfigMCR-Index. |
| clause 8.1 of [6, TS 38.214]. | |

### SL Physical Layer Structure

The configuration of the resources in the sidelink resource pool defines the minimum information required for a RX UE to be able to decode a transmission, which includes the number of sub-channels, the number of PRBs per sub-channels, the number of symbols in the PSCCH, which slots have a PSFCH and other configuration aspects not relevant to this invention.

However, the details of the actual sidelink transmission (i.e., the payload) are provided in the PSCCH (1st-stage SCI) for each individual transmission, which includes: the time and frequency resources, the DMRS configuration of the PSSCH, the MCS, PSFCH, among others.

An example of the SL slot structure is depicted in FIG. 8, where it shows a slot with PSCCH/PSSCH in an example (a) and a slot with PSCCH/PSSCH where the last symbols are used for PSFCH in an example (b).

Table 4 shows PSSCH DMRS configurations based on the number of used symbols and duration of the PSCCH.

TABLE 4

| | DM-RS position l̅ | | | | | |
|---|---|---|---|---|---|---|
| | PSCCH duration 2 symbols | | | PSCCH duration 3 symbols | | |
| l_{d} in | Number of PSSCH DM-RS | | | Number of PSSCH DM-RS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1st-stage SCI which is the payload sent within the PSCCH and follows the configuration as depicted in Table 4.

### SL HARQ Operation

The PSFCH was introduced during Release 16 to enable HARQ feedback over the sidelink from a UE that is the intended recipient of a PSSCH transmission (i.e., the RX UE) to the UE that performed the transmission (i.e., the TX UE). Within a PSFCH, a Zadoff-Chu sequence in one PRB is repeated over two OFDM symbols, the first of which can be used for AGC, near the end of the sidelink resource in a slot. An example slot format of PSCCH, PSSCH, and PSFCH is provided in the example (b) of FIG. 8. The Zadoff-Chu sequence as base sequence is configured or pre-configured per sidelink resource pool.

The time resources for PSFCH are configured or pre-configured to occur once every 0, 1, 2, or 4 slots according to TS 38.331. The HARQ feedback resource (PSFCH resource) is derived from the resource location of PSCCH/PSSCH.

For PSSCH-to-HARQ timing, there is a configuration parameter K with the unit of slot. The time occasion for PSFCH is determined from K. For a PSSCH transmission with its last symbol in slot n, HARQ feedback is in slot n+a where a is the smallest integer larger than or equal to K with the condition that slot n+a contains PSFCH resources. The time gap of at least K slots allows considering the RX UE's processing delay in decoding the PSCCH and generating the HARQ feedback. K can be equal to 2 or 3, and a single value of K can be configured or pre-configured per resource pool. This allows several RX UEs using the same resource pool to utilize the same mapping of PSFCH resource(s) for the HARQ feedback. With the parameter K, the N PSSCH slots associated with a slot with PSFCH can be determined.

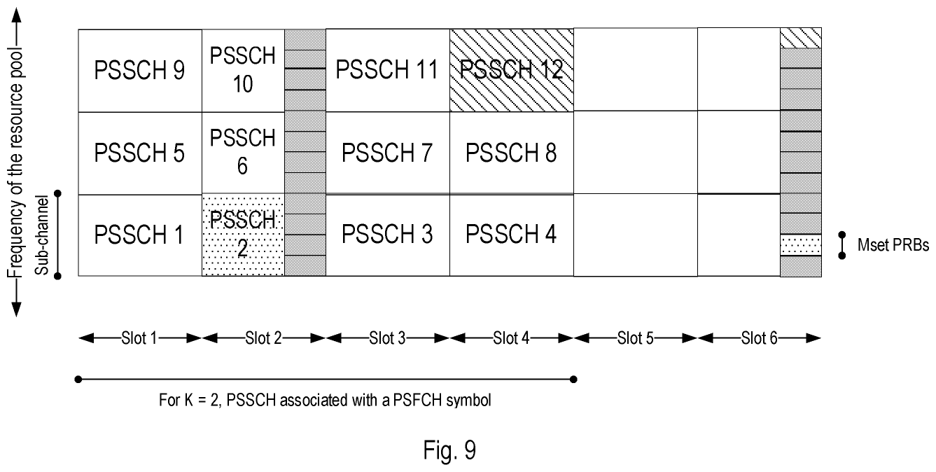

FIG. 9 illustrates an example of mapping between PSSCH resources and PSFCH resources in accordance with some implementations of the present disclosure. In the example of FIG. 9, the period of PSFCH resources is configured as N=4 (i.e., there will be 4 PSSCH slots associated with the PSFCH), and K (the sl-MinTimeGapPSFCH) is configured as 2. With L sub-channels in a resource pool and NPSSCH slots associated with a slot containing PSFCH, there are then N*L sub-channels associated with a PSFCH symbol. With M Physical Resource Blocks (PRBs) available for PSFCH in a PSFCH symbol, there are M PRBs available for the HARQ feedback of transmissions over N*L sub-channels.

With M configured to be a multiple of N*L, then a distinct set of Mₛₑₜ=M/(N*L) PRBs can be associated with the HARQ feedback for each sub-channel within a PSFCH period. The first set of Mₛₑₜ PRBs among the M PRBs available for PSFCH are associated with the HARQ feedback of a transmission in the first sub-channel in the first slot. The second set of Mₛₑₜ PRBs are associated with the HARQ feedback of a transmission in the first sub-channel in the second slot and so on.

As shown in FIG. 9, N=4, L=3 and with all PRBs in a PSFCH symbol available for PSFCH. In this example, the HARQ feedback for a transmission at PSSCH x is sent on the set x of Mₛₑₜ PRBs in the corresponding PSFCH symbol, with x=1, . . . , 12.

A set of Mₛₑₜ PRBs associated with a sub-channel are shared among multiple RX UEs in case of ACK/NACK feedback for groupcast communications (option 2) or in the case of different PSSCH transmissions in the same sub-channel.

For each PRB available for PSFCH, there are Q cyclic shift pairs available to support the ACK or NACK feedback of Q RX UEs within the PRB. For a resource pool, the number of cyclic shift pairs Q is (pre-)configured and can be equal to 1, 2, 3 or 6.

We can compute the number F of PSFCH resources available for supporting the HARQ feedback of a given transmission (in TS 38.213, F is denoted as R_{PRB,CS}^{PSFCH}). With each PSFCH resource used by one RX UE, F available PSFCH resources can be used for the ACK/NACK feedback of up to F RX UEs.

The F PSFCH resources available for multiplexing the HARQ feedback for the PSSCH can be determined based on two options:
a) either based on the L PSSCH sub-channels used by a PSSCH, where the F can be computed as:
   F=L PSSCH*Mset*Q PSFCHs (associated with the L PSSCH sub-channels of a PSSCH)
   Where,
      L represents the number of sub-channels of a PSSCH;
      Mₛₑₜ represents the number of PRBs for PSFCH associated with each sub-channel; and
      Q represents cyclic shift pairs available in each PRB.
b) or based only on the starting sub-channel used by a PSSCH (i.e., based only on one sub-channel for the case when L PSSCH>1).
   F=Mset*Q PSFCHs (associated with the starting sub-channel of a PSSCH)
   Where,
      Mₛₑₜ represents the number of PRBs for PSFCH associated with each sub-channel; and
      represents cyclic shift pairs available in each PRB.

Similar to the PUCCH in Release 15 NR Uu, the available F PSFCH resources are indexed based on a PRB index (frequency domain) and a cyclic shift pair index (code domain).

The mapping of the PSFCH index i (i=1, 2, . . . , F) to the PRBs and to the Q cyclic shift pairs is such that the PSFCH index i first increases with the PRB index until reaching the number of available PRBs for PSFCH. Then, it increases with the cyclic shift pair index, again with the PRB index and so on.

Among the F PSFCHs available for the HARQ feedback of a given transmission, an RX UE selects for its HARQ feedback the PSFCH with index i given by:

$$i = ( {T}_{ID} + {R}_{ID} ) mod F$$

where T_{ID} is the Layer 1 ID of the TX UE (indicated in the 2nd-stage SCI). R_{ID}=0 for unicast ACK/NACK feedback and groupcast NACK-only feedback (option 1).

For groupcast ACK/NACK feedback (option 2), R_{ID} is equal to the RX UE identifier within the group, which is indicated by higher layers. For a number X of RX UEs within a group, the RX UE identifier is an integer between 0 and X−1. An RX UE determines which PRB and cyclic shift pair should be used for sending its HARQ feedback based on the PSFCH index i. The RX UE uses the first or second cyclic shift from the cyclic shift pair associated with the selected PSFCH index i in order to send NACK or ACK, respectively.

By RX UEs selecting PSFCHs with index i, a TX UE can distinguish the HARQ feedback of different RX UE(s) (via the RX UE identifier, e.g., for groupcast option 2) and the HARQ feedback intended for the TX UE (via the Layer 1 ID of the TX UE, e.g. for unicast). As R_{ID}=0 for groupcast option 1, the RX UEs select the same PSFCH index i for their NACK-only feedback based solely on the Layer 1 ID TX UE identifier T_{ID}.

### Occupied Channel Bandwidth (OCB) Requirements

The scope of NR in unlicensed spectrum was limited to below 7 GHz bands. For this frequency range, the following spectrum regulatory requirements for the design of UL physical channels are captured from EU regulations.

ETSI specifies that OCB shall be between 80% and 100% of the declared Nominal Channel Bandwidth.

As per updated ETSI regulation, during a COT, equipment may operate temporarily with an Occupied Channel Bandwidth of less than 80% of its Nominal Channel Bandwidth with a minimum of 2 MHz.

Regulations on the maximum power spectral density are typically stated with a resolution bandwidth of 1 MHz. The ETSI specification requires a maximum Power Spectral Density (PSD) of 10 dBm/MHz for 5150-5350 MHz. It requires 10 KHz resolution for testing the 1 MHz PSD constraint and, thus, the maximum PSD constraint should be met in any occupied 1 MHz bandwidth.

In addition, the regulations impose a band specific total maximum transmission power in terms of EIRP, e.g., ETSI has EIRP limit of 23 dBm for 5150-5350 MHz.

The regulatory limitations in terms of OCB and PSD guided the design choices for the uplink channels of NR-unlicensed system.

In NR-SL, an SL Tx device can request HARQ feedback for its PSSCH transmission and there are two types of HARQ feedback available in NR-SL:
(i) ACK/NACK based which is applicable to unicast and groupcast HARQ Option 2;
(ii) NACK only feedback for groupcast HARQ Option 1.

For (i), it is well known in HARQ operation that Tx device may not receive anticipated HARQ feedback from Rx device for some reason, resulting in a HARQ feedback DTX detected at Tx device. HARQ feedback DTX can be treated as if a NACK was received and, therefore, Tx UE device may decide to perform a HARQ retransmission of a TB upon detecting a HARQ feedback DTX from Rx device. While for (ii), if there is HARQ feedback DTX, the Tx UE assumes that the TB was received successfully and therefore will not perform a HARQ retransmission.

Let us consider SL HARQ operation between Tx UE and Rx UE for unicast SL in unlicensed spectrum, referred to as SL-U. Due to possible LBT failure at Rx UE, Rx UE may not be able to send HARQ feedback on PSFCH to Tx UE as anticipated at slot n+a for the HARQ (re)transmission at slot n, and thus a HARQ feedback DTX may be detected at Tx UE. This is referred to as SL-U HARQ feedback DTX issue. Note that the same issue may occur in, e.g., LTE-NR SL coexistence in shared resources wherein Rx UE of NR SL may not be able to send HARQ feedback to its Tx UE because an LTE UE is transmitting in the anticipated PSFCH slot.

In summary, PSFCH transmissions in unlicensed band from RX UE are prone to LBT failures, which may result in unnecessary retransmissions for the case (i) will further exacerbate the occurrence of LBT failures, while for case (ii) will prevent a necessary retransmission. Providing multiple PSFCH occasions may reduce such issue, but it comes with the cost of needing more PSFCH resources and increased HARQ delay. Moreover, PSFCH in unlicensed band needs to meet stringent OCB and PSD requirement, which comes with additional overhead and complexity in order to comply with the regulations.

Implementations of the present disclosure provide a solution for transmission of HARQ feedback information so as to solve the above problems and one or more of other potential problems. According to the solution, a conditional resource mapping is introduced for HARQ feedback information corresponding to PSSCH transmissions to PSFCH feedback transmissions on a secondary band. The secondary band comprises a non-congested unlicensed band or a band where a channel access procedure is not required. Thus, the issue of HARQ DTX caused by LBT failures is mitigated

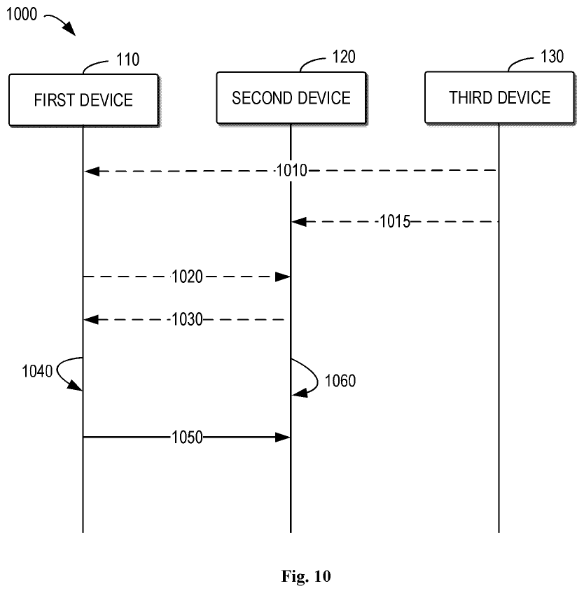

Hereinafter, principle of the present disclosure will be described with reference to FIGS. 10 to 16.

FIG. 10 illustrates a signaling chart illustrating a process 1000 for transmission of HARQ feedback information in accordance with some example embodiments of the present disclosure. For the purpose of discussion, the process 1000 will be described with reference to FIG. 1. The process 1000 may involve the first device 110, the second device 120 and the third device 130 as illustrated in FIG. 1. Although the process 1000 will be described in the communication network 100 of FIG. 1, this process may be likewise applied to other communication scenarios.

As shown, the first device 110 obtains a configuration of a first PSFCH resource in a secondary band. The first PSFCH resource is for HARQ feedback information in response to a sidelink data transmission from a second device 120 in an operating unlicensed band. The secondary band is different from the operating unlicensed band. The secondary band comprises a non-congested unlicensed band or a band where a channel access procedure is not required.

In some embodiments, the first device 110 may receive 1010 the configuration of the first PSFCH resource in the secondary band from the third device 130. For example, for operation in mode 1, the third device 130 may allocate PSFCH resources and indicate to the first device 110 in sidelink grant downlink control information (DCI) or as part of the RRC configuration (for example, for semi-persistent scheduling (SPS) or configured grant (CG)).

Alternatively, the configuration of the first PSFCH resource may be preconfigured in a configuration of a sidelink resource pool. For example, for operation in mode 2, the mapping of PSFCH to the secondary band may be configured as part of the configuration of the sidelink resource pool.

In some embodiments, determining whether a channel in an unlicensed band is congested or not may be based on Channel Busy Ratio (CBR) or Channel Occupancy Ratio (CR) measured level. If CBR or CR is above a certain threshold, the channel is determined to be congested; otherwise, it is determined to be uncongested. If at least one channel of the unlicensed band is determined to be uncongested, the unlicensed band may be determined to be uncongested.

In some embodiments, measurement and reporting of CBR for sidelink communication may be configured by a radio resource control (RRC) signaling.

In other embodiments, determining whether an unlicensed band is congested may be based on consistent LBT failure in the unlicensed band. In other words, if LBT failure counter exceeds a certain threshold in a period of time, the unlicensed band may be determined to be congested; otherwise, it may be determined to be uncongested.

In some embodiments, examples of the band where a channel access procedure is not required may include but are not limited to an Intelligent Transport Systems (ITS) band, and FR2 band.

With continued reference to FIG. 10, the first device 110 determines 1040 whether the HARQ feedback information is to be transmitted on the first PSFCH resource in the secondary band.

If the HARQ feedback information is to be transmitted on the first PSFCH resource in the secondary band, the first device 110 transmits 1050, to the second device 120, the HARQ feedback information on the first PSFCH resource. Otherwise, in some embodiment, the HARQ feedback information may be transmitted on a second PSFCH resource in the operating unlicensed band.

In some embodiments, the first device 110 may perform the channel access procedure for transmission of the HARQ feedback information in a second PSFCH resource in the operating unlicensed band. If the channel access procedure in the second PSFCH resource fails, the first device 110 may determine that the HARQ feedback information is to be transmitted on the first PSFCH resource in the secondary band.

In some embodiments, if the first device 110 determines that a resource for transmission of the HARQ feedback information only comprises the first PSFCH resource in the secondary band, the first device 110 may determine that the HARQ feedback information is to be transmitted on the first PSFCH resource without may perform a channel access procedure for transmission of the HARQ feedback information in the operating unlicensed band.

In some embodiments, the first device 110 may receive 1030, from the second device 120, an indication that the HARQ feedback information is to be transmitted on the first PSFCH resource in the secondary band. Alternatively, the first device 110 may receive the indication from the third device 130 serving the first device 110. For example, the first device 110 may receive the indication that the HARQ feedback information is to be transmitted on the first PSFCH resource together with the configuration of the first PSFCH resource in the secondary band in 1010.

In turn, the first device 110 may determine that the HARQ feedback information is to be transmitted on the first PSFCH resource based on the indication.

In some embodiments, the first device 110 may determine that the HARQ feedback information is to be transmitted on the first PSFCH resource in the secondary band by determining at least one of the following:
a CBR in the operating unlicensed band is above a first threshold,
a priority of the sidelink data transmission is above a second threshold,
reliability requirement for the HARQ feedback information is above a third threshold,
latency requirement for the HARQ feedback information is above a fourth threshold,
a Quality of Service level for the HARQ feedback information is above a fifth threshold,
the number of failures of the channel access procedure for transmission of the HARQ feedback information in the operating unlicensed band within a first observation window is above a sixth threshold,
a type of cast of the sidelink data transmission is groupcast,
lack of a valid shared COT associated with the operating unlicensed band, or
lack of time to acquire a new COT for the transmission of the HARQ feedback information in the operating unlicensed band,
a CBR in the secondary band is below an eighth threshold, or
the number of failures of the channel access procedure for transmission of the HARQ feedback information in the secondary band within a second observation window is above a ninth threshold.

In some embodiments, the lack of the valid COT may be determined based on determining that neither the first device 110, the second device 120 or any other device has initiated a COT which ends after the second PSFCH resource transmitting time, or that any device has previously provided a COT sharing indication with sufficient COT duration for transmitting on the second PSFCH resource.

In some embodiments, for example, for the case of HARQ option 1 in groupcast (for example, to request an additional retransmission, as the number of retransmissions occur it becomes less likely that another terminal device will also need a retransmission), if the number of retransmissions of a transmission block (TB) associated with the HARQ feedback information is above a seventh threshold, the first device 110 may determine that the HARQ feedback information is to be transmitted on the first PSFCH resource in the secondary band.

In some embodiments, if the first device 110 determines trigger of a HARQ retransmission for the sidelink data transmission before a start of a Discontinuous Reception (DRX) Off cycle, the first device 110 may determine that the HARQ feedback information is to be transmitted on the first PSFCH resource in the secondary band. For example, if the first device 110 may expect to enter a long DRX Off cycle within x slots and therefore want to trigger a HARQ retransmission before the start of the DRX Off cycle, the first device 110 may determine that the HARQ feedback information is to be transmitted on the first PSFCH resource in the secondary band.

In some embodiments, the first device 110 may determine that there will be no time to acquire a COT based on an estimation of a duration of a channel access procedure. For example, if a time interval associated with the contention window of the channel access procedure is longer than a time interval until the first PSFCH resource, there will be no time to complete the channel access procedure in the operating unlicensed band.

In some embodiments, the first device 110 may transmit 1020, to the second device 120, an indication that the first device 110 will switch to the secondary band for transmission of the HARQ feedback information. For example, the first device 110 may transmit the indication by higher layer signaling, MAC CE or RRC signaling based on at least one of the criteria as described above. For example, the first device 110 may transmit the indication based on determining the CBR in the operating unlicensed band is above a first threshold, or the number of failures of the channel access procedure for transmission of the HARQ feedback information in the operating unlicensed band within an observation window is above the sixth threshold.

In some embodiments, if the first device 110 has transmitted to the second device 120 the indication that the first device 110 will switch to the secondary band, the first device 110 will also determine to use the first PSFCH resource.

In some embodiments, the configuration of the first PSFCH resource in the secondary band indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

In some embodiments, if the HARQ feedback information is successfully transmitted to the second device 120 on a second PSFCH resource in the operating unlicensed band, the first device 110 may release the first PSFCH resource.

With continued reference to FIG. 10, on the side of the second device 120, the second device 120 obtains the configuration of the first PSFCH resource in the secondary band.

In some embodiments, the second device 120 may receive 1015 the configuration of the first PSFCH resource in the secondary band from the third device 130. Alternatively, the configuration of the first PSFCH resource may be preconfigured in the configuration of the sidelink resource pool.

In turn, the second device 120 determine 1060 whether to receive the HARQ feedback information on the first PSFCH resource in the secondary band.

If the HARQ feedback information is to be received on the first PSFCH resource in the secondary band, the second device 120 receive, from the first device 110, the HARQ feedback information on the first PSFCH resource.

In some embodiments, the second device 120 may detect the HARQ feedback information in a second PSFCH resource in the operating unlicensed band. If the HARQ feedback information is absent from the operating unlicensed band, the second device 120 may determine that the HARQ feedback information is to be received on the first PSFCH resource in the secondary band.

In some embodiments, the second device 120 may transmit 1030, to the first device 110, the indication that the HARQ feedback information is to be transmitted on the first PSFCH resource in the secondary band. In turn, the second device 120 may determine that the HARQ feedback information is to be received on the first PSFCH resource based on the indication.

In some embodiments, the second device 120 may receive 1020, from the first device 110, the indication that the first device 110 will switch to the secondary band for transmission of the HARQ feedback information. In turn, the second device 120 may determine that the HARQ feedback information is to be received on the first PSFCH resource based on the indication.

In some embodiments, if the HARQ feedback information is successfully received from the first device 110 on a second PSFCH resource in the operating unlicensed band, the second device 120 may release the first PSFCH resource.

With the process 1000, transmission of the HARQ feedback information in the secondary band which is not subject to LBT failures is more reliable. In other words, there is no risk of the HARQ feedback information not being transmitted. Thus, the process 1000 may avoid the issue of HARQ DTX and unnecessary retransmissions caused by missing of HARQ feedback information due to LBT failures.

In addition, with the process 1000, lower PSFCH resource overhead and lower HARQ delays may be achieved.

Furthermore, OCB and PSD requirements only apply to unlicensed band. PSFCH may need to be repeated in frequency (in interlaced RBs) along the operating band in order to meet these requirements. If the HARQ feedback information is transmitted in the first PSFCH resource in the secondary band that is a licensed band or ITS band, those requirements do not apply. Therefore, there is lower complexity and lower overhead since use of interlaces is not needed.

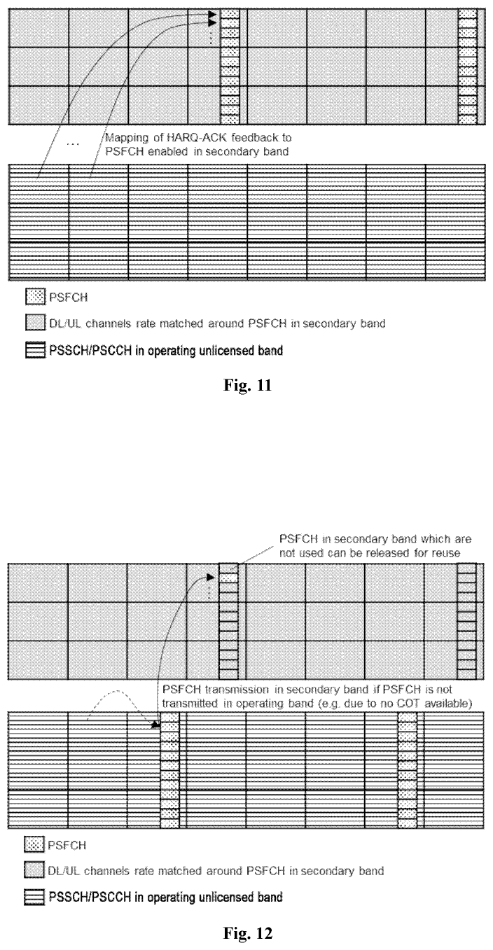

FIG. 11 illustrates an example of allocation of first PSFCH resources in the secondary band in accordance with some implementations of the present disclosure. In the example of FIG. 11, resources on a slot where the first PSFCH resources are mapped in the secondary band may not be dedicated for sidelink transmission. In other words, the resources can be used for downlink (DL) or uplink (UL) transmission and Physical Resource Blocks (PRBs) for DL/UL are rate matched (i.e., mapped) around the first PSFCH resources, as shown in FIG. 11. The first PSFCH resources in the secondary band may also include AGC symbols and guard interval before and after PSFCH symbols.

In this example, the mapping of HARQ feedback information to the first PSFCH resource in the secondary band follows similar mapping to the legacy mapping with a difference that the first PSFCH resource has an offset in frequency when comparing the operating band of a sidelink resource pool to the secondary band. For a total of M_{PRB,set}^{PSFCH}=S×N×M PRBs configured for PSFCH transmission in a PSFCH slot, the PSFCH allocation for slot-i and sub-channel-j is

$$[ ( i + j \cdot N ) \times M , ( i + 1 + j \cdot N ) \times M - 1 ] + δ ,$$

where S represents the number of sub-channels in the sidelink resource pool, N represents the number of PSSCH slots associated with one PSFCH slot and N may be equal to 1, 2 or 4, and M represents the number of PRBs for PSFCH per sub-channel and slot, δ represents a frequency offset between the first PSFCH resource in the secondary band and a second PSFCH resource in the operating unlicensed band. If δ is not configured or if δ is configured to 0, the use of the first PSFCH resource in the secondary band is deactivated. If δ is not configured to 0, the use of the first PSFCH resource in the secondary band is activated.

FIG. 12 illustrates an example of allocation of PSFCH resources in a secondary band in accordance with other implementations of the present disclosure. In the example of FIG. 12, the first device 110 may be configured with PSFCH resources in the operating unlicensed band, as well as with the first PSFCH resource in the secondary band. In addition, the first device 110 may use the first PSFCH resource in the secondary band only in case there is no available COT for transmission of the HARQ feedback information by the first device 110 in the operating unlicensed band. In this case, the second device 120 may determine that COT is available if it has provided a COT sharing indication, e.g., through SCI, to the first device 110, or if the second device 120 has previously received a COT sharing indication from the first device 110.

Alternatively, the first PSFCH resource in the secondary band is only used if the first device 110 experiences an LBT failure, which in this case will force the second device 120 to monitor whether PSFCH resources will be present firstly in the operating unlicensed band and then in the secondary band if it is determined that the first device 110 has not initiated a transmission of HARQ feedback information in the slot of PSFCH in the operating unlicensed band. In addition, in this case, the transmission of HARQ feedback information in the operating unlicensed band and in the secondary band may not be in the same slot. For instance, if the second device 120 could not find PSFCH resource in the operating unlicensed band in slot n, the second device 120 will further detect the first PSFCH resource in the secondary band in slot (n+a), where there is the time-offset “a” between the first PSFCH resource in the secondary band and the PSFCH resource in the operating unlicensed band in terms of the same HARQ feedback information. On the other hand, if the HARQ feedback information is transmitted or received successfully in the operating unlicensed band, the first PSFCH resource in the secondary band can be released.

In some embodiments, the time offset may be 0 or it may be higher than 0 depending for example on capability of the first device 110 and processing time to decide whether the first PSFCH resource in the secondary band should be used or not.

Given that the first PSFCH in the secondary band may likely not be used if the operating unlicensed band is un-congested, in some implementation, the same PSFCH resources can be reused as secondary for multiple RPs in unlicensed bands. Therefore, resource utilization for PSFCH allocated in the secondary band may be improved. In such cases where same PSFCH resource in the secondary band is reused, collisions may occasionally happen, so different code or sequence may be used during the mapping to identify the first PSFCH resource in the secondary band for different devices.

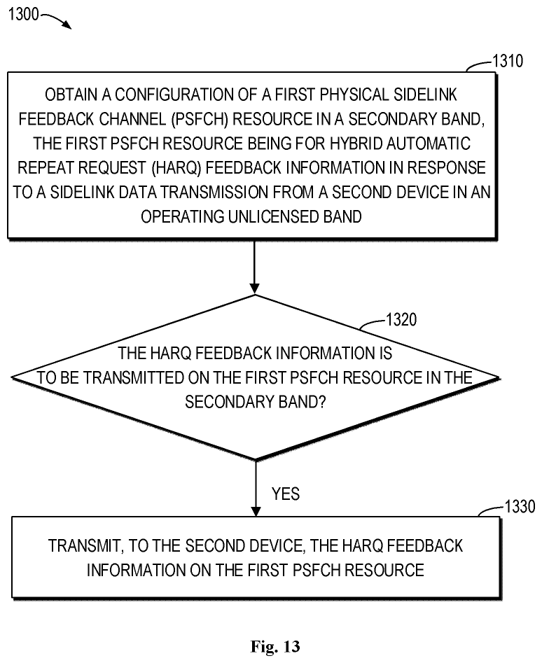

FIG. 13 illustrates a flowchart of an example method 1300 in accordance with some implementations of the present disclosure. In some implementations, the method 1300 can be implemented at a device, such as the device 110 or the device 120 as shown in FIG. 1. For the purpose of discussion, the method 1300 will be described with reference to FIG. 1 as performed by the first device 110 without loss of generality.

At block 1310, the first device 110 obtains a configuration of a first PSFCH resource in a secondary band, the first PSFCH resource being for HARQ feedback information in response to a sidelink data transmission from a second device in an operating unlicensed band. The secondary band comprises a non-congested unlicensed band or a band where a channel access procedure is not required.

At block 1320, the first device 110 determines whether the HARQ feedback information is to be transmitted on the first PSFCH resource in the secondary band.

At block 1330, if it is determined that that the HARQ feedback information is to be transmitted on the first PSFCH resource in the secondary band, the first device 110 transmits, to the second device, the HARQ feedback information on the first PSFCH resource.

In some embodiments, determining that the HARQ feedback information is to be transmitted on the first PSFCH resource in the secondary band comprises: performing the channel access procedure for transmission of the HARQ feedback information in a second PSFCH resource in the operating unlicensed band; and determining that the HARQ feedback information is to be transmitted on the first PSFCH resource in the secondary band based on a failure of the channel access procedure.

In some embodiments, determining that the HARQ feedback information is to be transmitted on the first PSFCH resource in the secondary band comprises: based on determining that a resource for transmission of the HARQ feedback information only comprises the first PSFCH resource in the secondary band, determining that the HARQ feedback information is to be transmitted on the first PSFCH resource without performing the channel access procedure for transmission of the HARQ feedback information in the operating unlicensed band.

In some embodiments, determining that the HARQ feedback information is to be transmitted on the first PSFCH resource in the secondary band comprises: receiving, from the second device or a third device serving the first device, an indication that the HARQ feedback information is to be transmitted on the first PSFCH resource in the secondary band; and determining that the HARQ feedback information is to be transmitted on the first PSFCH resource based on the indication.

In some embodiments, determining that the HARQ feedback information is to be transmitted on the first PSFCH resource in the secondary band by determining at least one of the following:
a Congestion Busy Ratio (CBR) in the operating unlicensed band is above a first threshold,
a priority of the sidelink data transmission is above a second threshold,
reliability requirement for the HARQ feedback information is above a third threshold,
latency requirement for the HARQ feedback information is above a fourth threshold,
a Quality of Service level for the HARQ feedback information is above a fifth threshold,
the number of failures of the channel access procedure for transmission of the HARQ feedback information in the operating unlicensed band within a first observation window is above a sixth threshold,
a type of cast of the sidelink data transmission is groupcast,
lack of a valid shared Channel Occupancy Time (COT) associated with the operating unlicensed band,
lack of time to acquire a new COT for the transmission of the HARQ feedback information in the operating unlicensed band,
the number of retransmissions of a transmission block associated with the HARQ feedback information is above a seventh threshold,
trigger of a HARQ retransmission for the sidelink data transmission before a start of a Discontinuous Reception Off cycle, or
a CBR in the secondary band is below an eighth threshold, or
the number of failures of the channel access procedure for transmission of the HARQ feedback information in the secondary band within a second observation window is above a ninth threshold.

In some embodiments, the method 1300 further comprises: transmitting, to the second device, an indication that the first device will switch to the secondary band for transmission of the HARQ feedback information.

In some embodiments, the configuration of the first PSFCH resource in the secondary band indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

In some embodiments, the configuration of the first PSFCH resource is received from a third device serving the first device.

In some embodiments, the configuration of the first PSFCH resource is preconfigured in a configuration of a sidelink resource pool.

In some embodiments, the method 1300 further comprises: performing rate matching of physical resource blocks of downlink or uplink transmission channels around the first PSFCH resource in the secondary band.

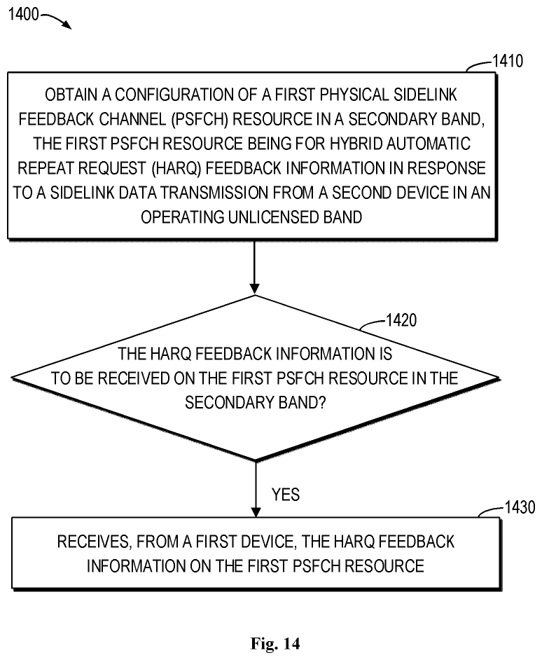

FIG. 14 illustrates a flowchart of an example method 1400 in accordance with some implementations of the present disclosure. In some implementations, the method 1400 can be implemented at a device, such as the device 110 or the device 120 as shown in FIG. 1. For the purpose of discussion, the method 1400 will be described with reference to FIG. 1 as performed by the second device 120 without loss of generality.

At block 1410, the second device 120 obtains a configuration of a first PSFCH resource in a secondary band. The first PSFCH resource is for HARQ feedback information in response to a sidelink data transmission from the second device 120 in an operating unlicensed band. The secondary band comprises a non-congested unlicensed band or a band where a channel access procedure is not required.

At block 1420, the second device 120 determines whether to receive HARQ feedback information on the first PSFCH resource in the secondary band.

At block 1430, if it is determined that the HARQ feedback information is to be received on the first PSFCH resource in the secondary band, the second device 120 receives, from a first device, the HARQ feedback information on the first PSFCH resource.

In some embodiments, determining that the HARQ feedback information is to be received on the first PSFCH resource in the secondary band comprises: detecting the HARQ feedback information in a second PSFCH resource in the operating unlicensed band; and in accordance with a determination that the HARQ feedback information is absent from the operating unlicensed band, determining that the HARQ feedback information is to be received on the first PSFCH resource in the secondary band.

In some embodiments, determining that the HARQ feedback information is to be received on the first PSFCH resource in the secondary band comprises: transmitting, to the first device, an indication that the HARQ feedback information is to be transmitted on the first PSFCH resource in the secondary band; and determining that the HARQ feedback information is to be received on the first PSFCH resource based on the indication.

In some embodiments, determining that the HARQ feedback information is to be received on the first PSFCH resource in the secondary band comprises: determining that the HARQ feedback information is to be received on the first PSFCH resource in the secondary band by determining at least one of the following:
a Congestion Busy Ratio (CBR) in the operating unlicensed band is above a first threshold,
a priority of the sidelink data transmission is above a second threshold,
reliability requirement for the HARQ feedback information is above a third threshold,
latency requirement for the HARQ feedback information is above a fourth threshold,
a Quality of Service level for the HARQ feedback information is above a fifth threshold,
the number of failures of the channel access procedure for transmission of the HARQ feedback information in the operating unlicensed band within a first observation window is above a sixth threshold,
a type of cast of the sidelink data transmission is groupcast,
lack of a valid shared Channel Occupancy Time (COT) associated with the operating unlicensed band,
lack of time to acquire a new COT for the transmission of the HARQ feedback information in the operating unlicensed band,
the number of retransmissions of a transmission block associated with the HARQ feedback information is above a seventh threshold,
trigger of a HARQ retransmission for the sidelink data transmission before a start of a Discontinuous Reception Off cycle,
a CBR in the secondary band is below an eighth threshold, or
the number of failures of the channel access procedure for transmission of the HARQ feedback information in the secondary band within a second observation window is above a ninth threshold.

In some embodiments, determining that the HARQ feedback information is to be received on the first PSFCH resource in the secondary band comprises: determining that the HARQ feedback information is to be received on the first PSFCH resource in the secondary band by: receiving, from the first device, an indication that the first device will switch to the secondary band for transmission of the HARQ feedback information; and determining that the HARQ feedback information is to be received on the first PSFCH resource based on the indication.

In some embodiments, a configuration of the first PSFCH resource indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

In some embodiments, the configuration of the first PSFCH resource is received from a third device serving the first device.

In some embodiments, the configuration of the first PSFCH resource is preconfigured in a configuration of a sidelink resource pool.

In some embodiments, the method 1400 further comprises: in accordance with a determination that the HARQ feedback information is successfully received from the first device on a second PSFCH resource in the operating unlicensed band, releasing the first PSFCH resource.

In some example implementations, an apparatus capable of performing any of the method 1300 (for example, the first device 110) may comprise means for performing the respective steps of the method 1300. The means may be implemented in any suitable form. For example, the means may be implemented in a circuitry or software module.

In some example implementations, the apparatus comprises: means for obtaining a configuration of a first PSFCH resource in a secondary band, the first PSFCH resource being for HARQ feedback information in response to a sidelink data transmission from a second device in an operating unlicensed band, the secondary band comprising a non-congested unlicensed band or a band where a channel access procedure is not required; means for determining whether the HARQ feedback information is to be transmitted on the first PSFCH resource in the secondary band; and means for transmitting, to the second device, the HARQ feedback information on the first PSFCH resource in accordance with a determination that the HARQ feedback information is to be transmitted on the first PSFCH resource in the secondary band.

In some embodiments, the means for determining that the HARQ feedback information is to be transmitted on the first PSFCH resource in the secondary band comprises: means for performing the channel access procedure for transmission of the HARQ feedback information in a second PSFCH resource in the operating unlicensed band; and means for determining that the HARQ feedback information is to be transmitted on the first PSFCH resource in the secondary band based on a failure of the channel access procedure.

In some embodiments, the means for determining that the HARQ feedback information is to be transmitted on the first PSFCH resource in the secondary band comprises: based on determining that a resource for transmission of the HARQ feedback information only comprises the first PSFCH resource in the secondary band, means for determining that the HARQ feedback information is to be transmitted on the first PSFCH resource without performing the channel access procedure for transmission of the HARQ feedback information in the operating unlicensed band.

In some embodiments, the means for determining that the HARQ feedback information is to be transmitted on the first PSFCH resource in the secondary band comprises: means for receiving, from the second device or a third device serving the first device, an indication that the HARQ feedback information is to be transmitted on the first PSFCH resource in the secondary band; and means for determining that the HARQ feedback information is to be transmitted on the first PSFCH resource based on the indication.

In some embodiments, the means for determining that the HARQ feedback information is to be transmitted on the first PSFCH resource in the secondary band comprises: means for determining that the HARQ feedback information is to be transmitted on the first PSFCH resource in the secondary band by determining at least one of the following:
a Congestion Busy Ratio (CBR) in the operating unlicensed band is above a first threshold,
a priority of the sidelink data transmission is above a second threshold,
reliability requirement for the HARQ feedback information is above a third threshold,
latency requirement for the HARQ feedback information is above a fourth threshold,
a Quality of Service level for the HARQ feedback information is above a fifth threshold,
the number of failures of the channel access procedure for transmission of the HARQ feedback information in the operating unlicensed band within a first observation window is above a sixth threshold,
a type of cast of the sidelink data transmission is groupcast,
lack of a valid shared Channel Occupancy Time (COT) associated with the operating unlicensed band,
lack of time to acquire a new COT for the transmission of the HARQ feedback information in the operating unlicensed band,
the number of retransmissions of a transmission block associated with the HARQ feedback information is above a seventh threshold,
trigger of a HARQ retransmission for the sidelink data transmission before a start of a Discontinuous Reception Off cycle, or
a CBR in the secondary band is below an eighth threshold, or
the number of failures of the channel access procedure for transmission of the HARQ feedback information in the secondary band within a second observation window is above a ninth threshold.

In some embodiments, the apparatus further comprises: means for transmitting, to the second device, an indication that the first device will switch to the secondary band for transmission of the HARQ feedback information.

In some embodiments, the configuration of the first PSFCH resource in the secondary band indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

In some embodiments, the configuration of the first PSFCH resource is received from a third device serving the first device.

In some embodiments, the configuration of the first PSFCH resource is preconfigured in a configuration of a sidelink resource pool.

In some embodiments, the apparatus further comprises: means for performing rate matching of physical resource blocks of downlink or uplink transmission channels around the first PSFCH resource in the secondary band.

In some example implementations, an apparatus capable of performing any of the method 1400 (for example, the second device 120) may comprise means for performing the respective steps of the method 1400. The means may be implemented in any suitable form. For example, the means may be implemented in a circuitry or software module.

In some example implementations, the apparatus comprises: means for obtaining, at a second device, a configuration of a first Physical Sidelink Feedback Channel (PSFCH) resource in a secondary band, the first PSFCH resource being for Hybrid Automatic Repeat Request (HARQ) feedback information in response to a sidelink data transmission from the second device in an operating unlicensed band, the secondary band comprising a non-congested unlicensed band or a band where a channel access procedure is not required; means for determining whether to receive the HARQ feedback information on the first PSFCH resource in the secondary band; and means for receiving, from a first device, the HARQ feedback information on the first PSFCH resource in accordance with a determination that the HARQ feedback information is to be received on the first PSFCH resource in the secondary band.

In some embodiments, the means for determining that the HARQ feedback information is to be received on the first PSFCH resource in the secondary band comprises: means for detecting the HARQ feedback information in a second PSFCH resource in the operating unlicensed band; and in accordance with a determination that the HARQ feedback information is absent from the operating unlicensed band, means for determining that the HARQ feedback information is to be received on the first PSFCH resource in the secondary band.

In some embodiments, the means for determining that the HARQ feedback information is to be received on the first PSFCH resource in the secondary band comprises: means for transmitting, to the first device, an indication that the HARQ feedback information is to be transmitted on the first PSFCH resource in the secondary band; and means for determining that the HARQ feedback information is to be received on the first PSFCH resource based on the indication.

In some embodiments, the means for determining that the HARQ feedback information is to be received on the first PSFCH resource in the secondary band comprises: means for determining that the HARQ feedback information is to be received on the first PSFCH resource in the secondary band by determining at least one of the following:
a Congestion Busy Ratio (CBR) in the operating unlicensed band is above a first threshold,
a priority of the sidelink data transmission is above a second threshold,
reliability requirement for the HARQ feedback information is above a third threshold,
latency requirement for the HARQ feedback information is above a fourth threshold,
a Quality of Service level for the HARQ feedback information is above a fifth threshold,
the number of failures of the channel access procedure for transmission of the HARQ feedback information in the operating unlicensed band within a first observation window is above a sixth threshold,
a type of cast of the sidelink data transmission is groupcast,
lack of a valid shared Channel Occupancy Time (COT) associated with the operating unlicensed band,
lack of time to acquire a new COT for the transmission of the HARQ feedback information in the operating unlicensed band,
the number of retransmissions of a transmission block associated with the HARQ feedback information is above a seventh threshold,
trigger of a HARQ retransmission for the sidelink data transmission before a start of a Discontinuous Reception Off cycle,
a CBR in the secondary band is below an eighth threshold, or
the number of failures of the channel access procedure for transmission of the HARQ feedback information in the secondary band within a second observation window is above a ninth threshold.

In some embodiments, the means for determining that the HARQ feedback information is to be received on the first PSFCH resource in the secondary band comprises: means for determining that the HARQ feedback information is to be received on the first PSFCH resource in the secondary band by: receiving, from the first device, an indication that the first device will switch to the secondary band for transmission of the HARQ feedback information; and determining that the HARQ feedback information is to be received on the first PSFCH resource based on the indication.

In some embodiments, a configuration of the first PSFCH resource indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

In some embodiments, the configuration of the first PSFCH resource is received from a third device serving the first device.

In some embodiments, the configuration of the first PSFCH resource is preconfigured in a configuration of a sidelink resource pool.

In some embodiments, the apparatus further comprises: in accordance with a determination that the HARQ feedback information is successfully received from the first device on a second PSFCH resource in the operating unlicensed band, releasing the first PSFCH resource.

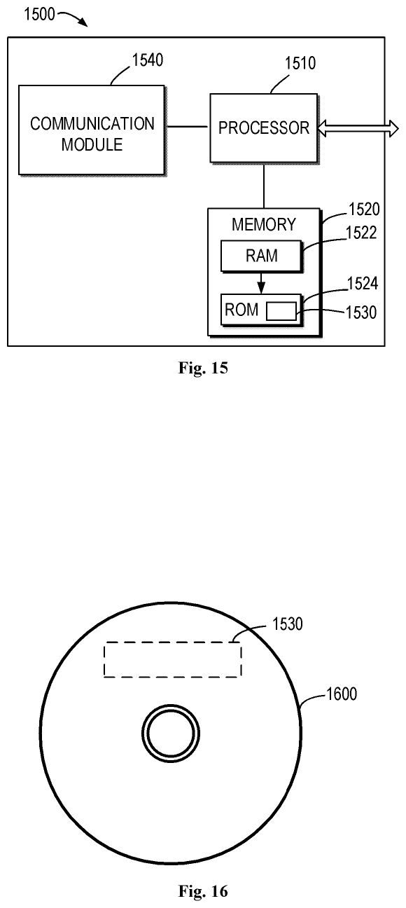

FIG. 15 is a simplified block diagram of a device 1500 that is suitable for implementing embodiments of the present disclosure. The device 1500 may be provided to implement the communication device, for example, the first device 110 (for example, an Rx UE) or the second device 120 (for example, a Tx UE) as shown in FIG. 1. As shown, the device 1500 includes one or more processors 1510, one or more memories 1520 coupled to the processor 1510, and one or more communication modules 1540 coupled to the processor 1510.

The communication module 1540 is for bidirectional communications. The communication module 1540 has at least one antenna to facilitate communication. The communication interface may represent any interface that is necessary for communication with other network elements.

The processor 1510 may be of any type suitable to the local technical network and may include one or more of the following: general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

The memory 1520 may include one or more non-volatile memories and one or more volatile memories. Examples of the non-volatile memories include, but are not limited to, a Read Only Memory (ROM) 1524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1522 and other volatile memories that will not last in the power-down duration.

A computer program 1530 includes computer executable instructions that are executed by the associated processor 1510. The program 1530 may be stored in the ROM 1524. The processor 1510 may perform any suitable actions and processing by loading the program 1530 into the RAM 1522.

The embodiments of the present disclosure may be implemented by means of the program 1530 so that the device 1500 may perform any process of the disclosure as discussed with reference to FIGS. 1 to 14. The embodiments of the present disclosure may also be implemented by hardware or by a combination of software and hardware.

In some example embodiments, the program 1530 may be tangibly contained in a computer readable medium which may be included in the device 1500 (such as in the memory 1520) or other storage devices that are accessible by the device 1500. The device 1500 may load the program 1530 from the computer readable medium to the RAM 1522 for execution. The computer readable medium may include any types of tangible non-volatile storage, such as ROM, EPROM, a flash memory, a hard disk, CD, DVD, and the like. FIG. 16 shows an example of the computer readable medium 1600 in form of CD or DVD. The computer readable medium has the program 1530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 1300 and 1400 as described above with reference to FIGS. 13 and 14. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A first device, comprising:
at least one processor; and
at least one memory including computer program code;
wherein the at least one memory and the computer program code are configured to, with the at least one processor, cause the first device to:
obtain a configuration of a first Physical Sidelink Feedback Channel (PSFCH) resource in a secondary band, the first PSFCH resource being for Hybrid Automatic Repeat Request (HARQ) feedback information in response to a sidelink data transmission from a second device in an operating unlicensed band, the secondary band comprising a non-congested unlicensed band or a band where a channel access procedure is not required;
determine whether the HARQ feedback information is to be transmitted on the first PSFCH resource in the secondary band; and
in accordance with a determination that the HARQ feedback information is to be transmitted on the first PSFCH resource in the secondary band, transmit, to the second device, the HARQ feedback information on the first PSFCH resource.

22. The first device of claim 21, wherein the first device is further caused to determine that the HARQ feedback information is to be transmitted on the first PSFCH resource in the secondary band by:
performing the channel access procedure for transmission of the HARQ feedback information in a second PSFCH resource in the operating unlicensed band; and
determining that the HARQ feedback information is to be transmitted on the first PSFCH resource in the secondary band based on a failure of the channel access procedure.

23. The first device of claim 21, wherein the first device is further caused to determine that the HARQ feedback information is to be transmitted on the first PSFCH resource in the secondary band by:
based on determining that a resource for transmission of the HARQ feedback information only comprises the first PSFCH resource in the secondary band, determining that the HARQ feedback information is to be transmitted on the first PSFCH resource without performing the channel access procedure for transmission of the HARQ feedback information in the operating unlicensed band.

24. The first device of claim 21, wherein the first device is further caused to determine that the HARQ feedback information is to be transmitted on the first PSFCH resource in the secondary band by:
receiving, from the second device or a third device serving the first device, an indication that the HARQ feedback information is to be transmitted on the first PSFCH resource in the secondary band; and
determining that the HARQ feedback information is to be transmitted on the first PSFCH resource based on the indication.

25. The first device of claim 21, wherein the first device is further caused to determine that the HARQ feedback information is to be transmitted on the first PSFCH resource in the secondary band by determining at least one of the following:
a Congestion Busy Ratio (CBR) in the operating unlicensed band is above a first threshold,
a priority of the sidelink data transmission is above a second threshold,
a reliability requirement for the HARQ feedback information is above a third threshold,
a latency requirement for the HARQ feedback information is above a fourth threshold,
a Quality of Service level for the HARQ feedback information is above a fifth threshold,
a number of failures of the channel access procedure for transmission of the HARQ feedback information in the operating unlicensed band within a first observation window is above a sixth threshold,
a type of cast of the sidelink data transmission is groupcast,
a lack of a valid shared Channel Occupancy Time (COT) associated with the operating unlicensed band,
a lack of time to acquire a new COT for the transmission of the HARQ feedback information in the operating unlicensed band,
a number of retransmissions of a transmission block associated with the HARQ feedback information is above a seventh threshold,
a trigger of a HARQ retransmission for the sidelink data transmission before a start of a Discontinuous Reception Off cycle, or
a CBR in the secondary band is below an eighth threshold, or
a number of failures of the channel access procedure for transmission of the HARQ feedback information in the secondary band within a second observation window is above a ninth threshold.

26. The first device of claim 21, wherein the first device is further caused to:
transmit, to the second device, an indication that the first device will switch to the secondary band for transmission of the HARQ feedback information.

27. The first device of claim 21, wherein the configuration of the first PSFCH resource in the secondary band indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

28. The first device of claim 21, wherein the first device is caused to receive the configuration of the first PSFCH resource from a third device serving the first device; or wherein the configuration of the first PSFCH resource is preconfigured in a configuration of a sidelink resource pool.

29. The first device of claim 21, wherein the first device is further caused to:
perform rate matching of physical resource blocks of downlink or uplink transmission channels around the first PSFCH resource in the secondary band.

30. A second device, comprising:
at least one processor; and
at least one memory including computer program code;
wherein the at least one memory and the computer program code are configured to, with the at least one processor, cause the second device to:
obtain a configuration of a first Physical Sidelink Feedback Channel (PSFCH) resource in a secondary band, the first PSFCH resource being for Hybrid Automatic Repeat Request (HARQ) feedback information in response to a sidelink data transmission from the second device in an operating unlicensed band, the secondary band comprising a non-congested unlicensed band or a band where a channel access procedure is not required;
determine whether to receive the HARQ feedback information on the first PSFCH resource in the secondary band; and
in accordance with a determination that the HARQ feedback information is to be received on the first PSFCH resource in the secondary band, receive, from a first device, the HARQ feedback information on the first PSFCH resource.

31. The second device of claim 30, wherein the second device is caused to determine that the HARQ feedback information is to be received on the first PSFCH resource in the secondary band by:
detecting the HARQ feedback information in a second PSFCH resource in the operating unlicensed band; and
in accordance with a determination that the HARQ feedback information is absent from the operating unlicensed band, determining that the HARQ feedback information is to be received on the first PSFCH resource in the secondary band.

32. The second device of claim 30, wherein the second device is caused to determine that the HARQ feedback information is to be received on the first PSFCH resource in the secondary band by:
transmitting, to the first device, an indication that the HARQ feedback information is to be transmitted on the first PSFCH resource in the secondary band; and
determining that the HARQ feedback information is to be received on the first PSFCH resource based on the indication.

33. The second device of claim 30, wherein the second device is caused to determine that the HARQ feedback information is to be received on the first PSFCH resource in the secondary band by determining at least one of the following:
a Congestion Busy Ratio (CBR) in the operating unlicensed band is above a first threshold,
a priority of the sidelink data transmission is above a second threshold, reliability requirement for the HARQ feedback information is above a third threshold,
a latency requirement for the HARQ feedback information is above a fourth threshold,
a Quality of Service level for the HARQ feedback information is above a fifth threshold,
a number of failures of the channel access procedure for transmission of the HARQ feedback information in the operating unlicensed band within a first observation window is above a sixth threshold,
a type of cast of the sidelink data transmission is groupcast,
a lack of a valid shared Channel Occupancy Time (COT) associated with the operating unlicensed band,
a lack of time to acquire a new COT for the transmission of the HARQ feedback information in the operating unlicensed band,
a number of retransmissions of a transmission block associated with the HARQ feedback information is above a seventh threshold,
a trigger of a HARQ retransmission for the sidelink data transmission before a start of a Discontinuous Reception Off cycle,
a CBR in the secondary band is below an eighth threshold, or
a number of failures of the channel access procedure for transmission of the HARQ feedback information in the secondary band within a second observation window is above a ninth threshold.

34. The second device of claim 30, wherein the second device is caused to determine that the HARQ feedback information is to be received on the first PSFCH resource in the secondary band by:
receiving, from the first device, an indication that the first device will switch to the secondary band for transmission of the HARQ feedback information; and
determining that the HARQ feedback information is to be received on the first PSFCH resource based on the indication.

35. The second device of claim 30, wherein a configuration of the first PSFCH resource indicates at least one of the following:
a time resource comprised in the first PSFCH resource,
a frequency resource comprised in the first PSFCH resource,
a sequence resource comprised in the first PSFCH resource,
an association between sidelink data transmissions in sub-channels of a sidelink resource pool in the operating unlicensed band and the first PSFCH resource in the secondary band,
a frequency offset between the first PSFCH resource and a second PSFCH resource in the operating unlicensed band, or
a time offset between the first PSFCH resource and the second PSFCH resource in the operating unlicensed band.

36. The second device of claim 35, wherein the second device is caused to receive the configuration of the first PSFCH resource from a third device serving the first device; or
wherein the configuration of the first PSFCH resource is preconfigured in a configuration of a sidelink resource pool.

37. A method for a first device, comprising:
obtaining a configuration of a first Physical Sidelink Feedback Channel (PSFCH) resource in a secondary band, the first PSFCH resource being for Hybrid Automatic Repeat Request (HARQ) feedback information in response to a sidelink data transmission from a second device in an operating unlicensed band, the secondary band comprising a non-congested unlicensed band or a band where a channel access procedure is not required;
determining whether the HARQ feedback information is to be transmitted on the first PSFCH resource in the secondary band; and
in accordance with a determination that the HARQ feedback information is to be transmitted on the first PSFCH resource in the secondary band, transmitting, to the second device, the HARQ feedback information on the first PSFCH resource.

38. The method of claim 37, further comprising:
performing the channel access procedure for transmission of the HARQ feedback information in a second PSFCH resource in the operating unlicensed band; and
determining that the HARQ feedback information is to be transmitted on the first PSFCH resource in the secondary band based on a failure of the channel access procedure.

39. The method of claim 37, further comprising:
based on determining that a resource for transmission of the HARQ feedback information only comprises the first PSFCH resource in the secondary band, determining that the HARQ feedback information is to be transmitted on the first PSFCH resource without performing the channel access procedure for transmission of the HARQ feedback information in the operating unlicensed band.

40. The method of claim 37, further comprising:
receiving, from the second device or a third device serving the first device, an indication that the HARQ feedback information is to be transmitted on the first PSFCH resource in the secondary band; and
determining that the HARQ feedback information is to be transmitted on the first PSFCH resource based on the indication.
